(19) United States
(12) Patent Application Publication
(10) Pub. No.: US 2011/0306255 A1
(43) Pub. Date: Dec. 15, 2011

(54) Strong Materials of Construction and Coatings Comprising Inorganic Binders with Fibre Reinforcement

(76) Inventor: Jorg Rathenow, Wiesbaden (DE)

(21) Appl. No.: 12/935,843

(22) PCT Filed: Mar. 31, 2009
(86) PCT No.: PCT/EP2009/053823

§ 371 Date: Aug. 18, 2011

(30) Foreign Application Priority Data
Mar. 31, 2008 (DE) 10 2008 016 719.3

(51) Int. Cl. B32B 5/02; D03D 9/00

(52) U.S. Cl. 442/1; 442/59; 442/172; 442/180; 442/153; 442/171; 442/170; 442/169; 442/179; 442/168; 442/164

(57) ABSTRACT

The invention relates to a composition including an acid-stable inorganic binder and fibres. The composition includes at least one inorganic binder and fibres, wherein the inorganic binder comprises water glass, the fraction of the composition which is attributable to water glass preferably being in the range from 2% to 99% by weight or 6% to 94% by weight or 11% to 89% by weight or 21% to 79% by weight. The fibre material is present as a weave and/or knit and/or scrim and/or net and/or brous nonwoven web and/or as hollow fibres. Owing to its high strength coupled with low weight, this material of construction is very useful for fabricating ready-made components for structural and civil engineering. In addition, it is also very easy to produce structural components and engineered structures on site. It is possible to realize very light components, to achieve very delicate geometries and, owing to the favourable strength-to-weight ratio, to build unusually high structures.

The invention relates to a composition including an acid-stable inorganic binder and fibres.

### PRIOR ART

Composite materials of construction comprising plastic and glass fibres are used inter alia as mouldings in car industry or are used as a shell for ships, as pipes, containers and in plant manufacturing. Patent EP 0 004 712 describes a production method for plastic articles, wherein liquid plastic-forming constituents and liquid medium-borne cut glass fibres are mixed and subsequently hardened in a mould.

However, the limited resistance of such materials of construction to acids, alkalis, solvents, UV radiation and high temperatures restricts their field of application. In addition, such materials are expensive due to their petroleum-borne nature and their production and processing is not harmless owing to necessary harmful additives. As an example the use of amines for curing epoxide-type materials of construction can be mentioned.

In the patent application DE 19 532 638 a mineral composite material of construction with glass fibre reinforcement is disclosed, the matrix of which is based on a hydraulic binder, which pores are filled with a polymer. As in other similar references, also in this document only cement is considered as a binder. Contrary to the mentioned similar references, in DE 19 532 638 however at least one of the main problems with the use of cement is partially solved. Namely, a cement or CSH matrix, respectively, contains a plurality of pores. This pore space is filled with a strongly alkaline liquid (pH 13-14) resulting inter alia from alkalis which find their way into the binder via the cement clinker. On the other hand, such an alkaline milieu damages the incorporated glass fibres. However, not only the present pore liquid is a problem. In addition, the pores facilitate the penetration of liquids from outside of the material of construction to the reinforcement elements which are incorporated in the cement and thus result in their damage, for example by corrosion. By filling the pore space with polymers according to DE 19 532 638, the accumulation of such pore liquids and/or the penetration of liquids from outside are reduced.

However generally cement systems are not acid-stable and the tolerance for high temperatures will be decreased by the use of polymers. In addition, the limited strength of these materials of construction results in a high wall thickness-to-strength ratio. So in the case of reinforcement, e.g. with steel reinforcement, also e.g. high buildings can be realised, but owing to the high dead load here already physical limits with respect to e.g. the height of buildings are reached.

Thus it is an object of the present invention to provide a material of construction having high resistance to acids, alkalis (pH 1-14), brine, soft water and solvents as well as to temperatures of up to 500° C., with high strength coupled with low weight and which can be easily processed. In addition, the production, processing, use and disposal should be harmless for the user. Furthermore, by the use of mass raw materials a low price should be possible and the composite material of construction according to the present invention should have a high bending tensile strength which allows an effective and efficient construction directly from this material. It should be possible to apply high layer thicknesses in one process step to achieve high abrasion resistance without the danger of crack formation. The material of construction should also be machinable at temperatures of 5° C. to 50° C. and should have high tightness. In addition, the blooming by salts should be prevented and the material of construction should also have excellent adhesion on mineral materials of construction such as glass, but also on metals, wood and partially on plastics such as for example extruded polystyrene.

The material of construction or composite material of construction according to the present invention respectively mean the composite of fibres and inorganic binder as well as additives as is described hereinafter with the term “composition”.

The above-mentioned object is solved according to the present invention by the composition including at least one inorganic binder and fibres, wherein the inorganic binder comprises water glass, the fraction of the composition which is attributable to water glass preferably being in the range from 2% to 99% by weight or 6% to 94% by weight or 11% to 89% by weight or 21% to 79% by weight.

Generally, as an inorganic binder the following are of particular interest:
a SiO₂ matrix, for example of water glass, and/or a latent-hydraulic binder. These are in particular materials of construction as they are described e.g. in EP 1 081 114, wherein the content of the mentioned patent document explicitly should be considered as a part of the present application.
a calcium-silicate-hydrate (CSH) matrix, for example a cement or latent-hydraulic binder matrix in which the formation of Ca(OH)₂ is prevented by the formulation and/or a catalyst. These are in particular materials of construction as they are described e.g. in EP 1 236 702, wherein the content of the mentioned patent document explicitly should be considered as a part of the present application.

In particular, compositions are of interest which contain besides the above-mentioned water glass at least one further inorganic binder or at least one filler which is preferably of inorganic nature, the fraction which is attributable to the further inorganic binder, filler and the fibres together preferably being in the range from 0.1% to 79% by weight or 16% to 49% by weight or 26% to 39% by weight. In this case, the information given in % by weight always refers to the total composition, i.e. the composite material of construction.

Also of interest are compositions of the following kinds:
a composition including one or more water glasses and a flexibilisation e.g. by the admixture of gum granulate, PE, PP, atactic PE or PE, liquid polymer dispersions or powdery polymers such as pure acrylates, styrene acrylate, polyurethane, latex or rubber etc., as well as at least 10% by weight of one or more materials of the group “slag sand, micro silica, slag, fly ash, trass powder, brick powder, oil shale, glass, quartz sand”, wherein materials of the group “slag sand, glass, quartz sand” are preferable.
a composition including water glass powder and at least on water glass hardener as well as more than 10% by weight of slag sand and at least one inorganic filler, wherein preferably the inorganic filler is quartz sand or glass.
a composition including water glass powder as well as 10% to 60% by weight of at least one latent-hydraulic binder of the group “slag sand, fly ash, trass powder, brick powder, oil shale, micro silica” and at least one cement as well as 0.05% to 40% by weight, preferably 5% to 30% by weight, particularly preferably 11% to 20% by weight of a substance which controls the setting reaction and which may be inter alia a metal salt of the group “metal hydroxide, metal oxide, carbonaceous metal salt, sulphurous metal salt, nitrogenous metal salt, phosphorus metal salt, halogen-containing metal salt”, wherein preferably such a metal salt is an alkali salt.
a composition including a cement or latent-hydraulic binder in which the formation of CaOH is prevented by the formulation and/or a catalyst.

In this case, the information given in % by weight always refers to the total composition, i.e. the composite material of construction.

The addition of cement in an amount of less than 20% by weight, preferably of 5% to 15% by weight is possible. The cement reacts with SiO₂ of the water glass under formation of CSH without interfering side reactions to calcium hydroxide. This results in an earlier fast water resistance of the material of construction. Nevertheless, the detrimental properties of a matrix essentially consisting of cement are not observed, because the cement CSH-matrix is completely surrounded, i.e. in a capillary pore-dense manner, by the SiO₂ matrix of the water glass.

The mentioned inorganic binders may also be plasticized, for example according to a method as described in EP 1 081 110. In addition, the above-mentioned binders can also be optimised by respective formulation alterations and/or with additives for the use in combination with the fibre materials over a broad range also with respect to the processing properties. A person skilled in the art knows respective additives for varying the pot life, the processing viscosity or the through drying time. By the addition of binders, adhesion agents, thickeners, flowing agents and flowing enhancers, respectively, or liquifiers, as well as catalysts, complexing agents, the use of different grading curves or the modification of the amount of fillers the properties of the material of construction can be adjusted according to the needs. However, here it is important to prevent the side reactions which result in the formation of Ca(OH)₂ to ensure the stability of the material of construction.

The added fibres may consist of various materials such as glass, stone, paper, wood, cellulose, polypropylene (PP), polyethylene (PE), polyethylene terephthalate, aramid, carbon, nylon, iron, steel, titanium, gold, silver, molybdenum, tungsten, niobium, etc. In this case, also mixtures of fibres consisting of different materials or the presence of the fibres as hollow fibres, in bulk form, as filaments, weave, knit, net, scrim, fibrous nonwoven web, in broken, cut, chopped or ground form may be advantageous, wherein long as well as short and also thick and thin fibres can be used. A preferable fibre length is 1 m to 10 nm, preferably 0.1 to 10 cm, particularly preferably 0.5 to 3 cm, and the preferable fibre diameter is 1 m to 10 nm, preferably 0.01 to 5 mm, particularly preferably 0.1 to 2 mm. The choice of the fibres strongly depends on the properties of the material of construction to be achieved. If the fibres become too long, then the processing will be impeded and more fibre breaks will occur. Thinner fibres facilitate a higher packing density.

The fraction of said composition which is attributable to the fibres preferably is at least 0.001% by weight or at least 0.5% by weight or at least 4% by weight or at least 9% by weight. The fraction which is attributable to the fibres inter alia depends on the surface and/or the degree of comminution of the fibre matrix.

Nevertheless, when here the addition of fibres is called “admixing”, “adding”, etc. and the composition according to the present invention is described as a “mixture of substances”, “mixture”, etc., this does not only mean the production of a mixture or a homogenous mixture consisting of binder, additives and fibres. Rather a state (or its production, respectively) is meant, in which the inorganic binder at least partially and preferably essentially fills the space between the fibres. This also comprises an impregnation of fibre objects which already have a certain form, for example corrugated boards.

Normally it is desired that the inorganic matrix consisting of binder and additives virtually completely fills the space between the fibres. Since the binder is able to surround the fibres completely and in a liquid-tight, i.e. in a capillary pore-free manner and thus to protect them from adverse influences, a substantially broader range of fibres than is known from prior art can be used. However, in this case the material of construction remains diffusible for water vapour. In particular, the use of the mentioned binder also facilitates the use of cheap fibres having low durability with respect to their chemical resistance in the production of composite materials of construction, and nevertheless to achieve an extraordinarily strong material of construction. The addition of fibres, for example of the recycling process, contributes to the lower production cost and facilitates the production of thinner, lighter materials of construction through this gain of stability.

In particular, the composition according to the present invention is an alternative to materials of construction with fibre reinforcement on the basis of plastics, for example comprising epoxide resins and glass fibres. Such materials of construction inter alia are used in chemical plants due to their good resistance. However, the material of construction according to the present invention has a remarkably higher resistance to chemicals (concentrated acids and bases as well as solvents) than such composites comprising fibres and plastic, and its production is substantially cheaper.

The processing in an extruder, via a vacuum method or with rendering processing machines as well as the direct application onto mineral surfaces such as brick, concrete, stonework, etc. are also possible like the use of the mentioned composite material of construction as a part of a layering or also in the form of a self-supporting material of construction.

A construction with more than one layer, for example with the incorporation into a mould or onto a moulded article can be realised as follows: As the first layer e.g. a version of the material of construction which has been optimised with respect to chemical resistance according to the present invention or an extremely wear-resistant variant can be used. This layer will then be covered for example with a second layer of a fibre placement soaked with binder which results in high mechanical stability of the object. A third layer can have decorative function or can increase the durability with respect to mechanical load or UV radiation. In addition, there is the possibility to cover the outer layer with paints, high gloss or lacquers.

Of particular interest is also the use of the mentioned composite material of construction as a coating, for example on objects which are subject to corrosion comprising steel or iron such as pipelines, parts of ships, sheet pilings, parts of off-shore properties or chemical plants.

The material of construction according to the present invention is not only suitable as a coating, but also as a cheap and highly resistant basic substance for moulded articles or self-supporting materials of construction. In the production of self-supporting materials of construction and structural components comprising the mentioned composite material of construction e.g. in a first step fibres, for example in the form of waste paper chips, are mixed with the binder which may be present in powder form. In a second step blending of the mixture of the binder and the fibres with water or—when plasticizing is desired, with polydispersion is conducted. According to the field of application of the object to be produced further additives are possible (cf. above). Subsequently, the material of construction can be cast, spread with brush, roll or spatula or applied by injection. The application is made into the interior or onto the exterior of a mould, wherein said form for example can also be a sheet for the production of plates. Of course here also a finishing with commercially available paints or lacquers for a decorative design is possible.

In a further embodiment the mentioned composite material of construction can also be used as an adhesive, wherein i.e. the adhesion on glass or ceramic, the bonding of glass e.g. on mineral grounds, metals or wood etc. are of interest. This will be facilitated by the excellent adhesion properties of the material of construction which are in turn the result of the densely sealed matrix. The material of construction is also suitable for bonding of wood—in the form of saw dust, wood chips, wood wool or shavings—into plates or objects with other forms.

Advantageous modifications of the composite material of construction are for example:
a flexibilisation e.g. by the admixture of gum granulate, PE, PP, atactic PE or PE, liquid polymer dispersions or powdery polymers such as pure acrylates, styrene acrylate, polyurethane, latex or rubber etc.
an increase of the insulating property e.g. by the admixture of hollow fibres (analogous to polar bear-skin), organic and/or inorganic lightweight additives such as styrofoam, polystyrene, polyurethane foam, nanogel (company Cabot), expanded gas, expanded clay, water glass foam, expanding polystyrene, wood wool, wood chips, insulating cork or Poraver etc.
a variation of the electric and/or thermal conductivity e.g. by the admixture of soot, metal powder, metal compounds, oriented carbon fibres, conductive polymers, conductive metal oxides or also nanometre-scale indium tin oxide for example for transparent coatings.
production of translucent or transparent materials of construction by the admixture of transparent fillers such as glass flour, for example from recycling glass, or by the use of pure water glass without the use of fillers.
an increase of the wear resistance e.g. by the admixture of boron compounds, silicon carbide, diamond, corundum, molybdenum sulphide, etc.
an improvement of the cellular adhesion and biocompatibility e.g. by surface coatings which are applied by means of chemical or physical vapour deposition, i.e. so-called CVD and PVD surface coatings, respectively. This improves the suitability of the material of construction according to the present invention for example for the production of bioreactors, laboratory materials or also as medical implants or coatings for medical implants.
creating a defined porosity in the binder matrix and/or the surface. This is realised for example by the targeted incorporation of dummy substances such as waxes, paraffins, volatile compounds, compounds which can be washed out (e.g. polyvinylpyrrolidone/PVP) or thermally decomposable compounds which can subsequently be washed out or thermally decomposed, respectively.
optional pigmentation, hydrophobing, oleophobing, addition of lubricating agents, Teflon, biocides, polymers for plasticizing, odorous substances or additives and/or fibres for capillary activation.

Due to its properties the composite material of construction according to the present invention is versatile.

In the case of boat building it can be used for example in the form of a first slurry layer as an alternative for gel coat, wherein here in an alternative way also only the binder can be used. The next step of the coating process is conducted by the application of a slurry of the composite material of construction which is reinforced by a weave of glass fibres and the binder matrix of which consists for example of SD1 (a product of the company Remmers). However, also a classical gel coat structure in combination with a second layer comprising a composite material of construction with glass fibre reinforcement according to the present invention is possible. Such a structure ensures a very high abrasion resistance as well as a very low distortion tendency, wherein an optional flexibilisation can be achieved by the addition of polymer dispersions, if necessary. In this case the resulting layer structure is watertight and smooth and/or the skid resistance can arbitrarily be adjusted by the adjustment of the grading curve. So the glass fibre matrix is excellently protected and, in addition, the virtually monolithic composite has very good adhesion properties. Furthermore, the material of construction can be coloured with conventional pigments and ensures an excellent colour fastness and UV stability. As antifouling agents substances such as waxes, biocides or silicone oils can be mixed in. Also possible is lightweight design with organic or inorganic lightweight additives in the binder matrix and/or by the use of carbon or lightweight fibres. Each further arbitrary paint or lacquer structure with conventional coating systems is possible.

In particular, the composite material of construction according to the present invention can also be used as a coating or also as a basic substance for pipes and containers. In this connection a multilayered structure is advantageous. This structure has, for example, an inner layer which is adjusted to abrasion, temperature, solvent (polar and nonpolar) and chemical resistance (pH 1-15) (for example SiO₂ system). As the outer layer a flexibilised and thermally insulating layer (for example CSH matrix with glass fibre reinforcement) may be advantageous. Since the material of construction according to the present invention guarantees an excellent fibre composite and/or a monolithic bonding of the fibres and has a nearly identical coefficient of thermal expansion everywhere (low thermal tension), it is also suitable for cryogenic and high temperature use. If such functions have not already been integrated into the above-mentioned layers, the mentioned objects can be provided with further properties, such as electric conductivity, thermal insulation, UV protection, etc., by additional layers.

Owing to its high strength coupled with low weight, this material of construction is very useful for fabricating ready-made components for structural and civil engineering. In addition, it is also very easy to produce structural components and engineered structures on site. For that the reinforcement weaves or corrugated board geometries are incorporated e.g. into hoardings and the binder is e.g. pumped in, compacted and hardened. Thus it is possible to realise very light (cheap) components, to achieve very delicate geometries and, owing to the favourable weight-to-strength ratio, to build unusually high structures.

A further field of application for the composite material of construction according to the present invention is the impregnation of cheap and instable materials of construction on the basis of fibres, such as for example corrugated boards. A single-sided coating or impregnation with the binder which optionally contains further additives improves the mechanic, physical and chemical resistance thereof and results in e.g. water resistance thereof. Single or more layers of open or closed corrugations of corrugated boards can be bonded with the material of construction according to the present invention and thus give a structural component having flow passages which can be used e.g. for heat exchange applications, as support material for bioreactor processes or as insulating and/or lightweight material. In such corrugated board structures also after drying a capillary activity and/or porosity which is remarkably lower or even close to zero perpendicular to the paper plane can be adjusted by different degrees of impregnation of the paper in the board plane. This means that through the impregnation and orientation of the corrugated board sheets the targeted adjustment of the capillary activity is possible. This is of particular importance with respect to the construction physics to be able to control and/or guarantee the moisture transport in the wall. This shows that not in each case a complete filling of the space between the fibres has to be desired, but the degree of impregnation can specifically be used to control the properties of the composite material of construction. In addition, lightweight additives can provide a better thermal insulation or the interior of the corrugated board can be filled to achieve a higher mechanic durability and/or stability of the structural component. As already described above, with respective additives also some other properties such as conductivity can be influenced. Of course also coatings of gypsum plasterboards, metals, alloys such as steel, as well as wood or wood composite panels can be used. Such a coating comprising the composite material of construction according to the present invention can be applied on one side or on both sides, and improves the mechanic, physical and chemical resistance, and/or provides water resistance and fire retardancy. These properties predestinate the material of construction according to the present invention also for the use as a support for catalysts, in micro reactors, as molecular sieve or membrane, because such objects are often used in a chemically aggressive environment or in an environment which is challenging with respect to the temperature thereof. In the case of the use as a support for catalysts the catalyst can already be mixed during the production of the material of construction or can be applied later.

A further field of application of the composite material of construction according to the present invention relates to the use of paper fibres. In this case the binder is mixed with paper fibres, e.g. in the form of waste paper chips, as well as optionally with lightweight additives or other additives. After drying strong plates or other bodies having good insulating, conductive, mechanic and/or thermal properties and a good resistance to chemicals can be achieved. The production cost of such a material of construction is low. Alternatively or in addition, the binder can also be mixed with other cheap materials which optionally result from recycling such as polymer chips and/or fibres, construction waste or wood chips. These materials can be used singly and also in combination and the thus-produced composite materials of construction are excellently suitable as fillers for the equalisation of any surfaces due to their adhesion properties.

In the following the invention is explained by means of some embodiment examples, wherein of course the invention is not limited to these mentioned embodiments. Also the content of all references (patents, patent applications, etc.) which are mentioned in the present application should be understood as a part of the content of this application, because it is not expedient to repeat the prior art.

### EXAMPLE 1

A substance mixture consisting of 27% by weight of potassium water glass powder, 23% by weight of slag sand, 4% by weight of Portland cement, 0.5% by weight of lithium hydroxide, 0.5% by weight of potassium sulphate and 45% by weight of glass powder is mixed with water and is applied onto a sheet, wherein before also fibres, e.g. glass fibres, can be added. Subsequently a glass fibre weave is applied onto this layer, wherein this can be conducted in wet-wet-state, after drying or also after complete drying of the layer. The glass fibre weave is soaked and covered with the same substance mixture as described above. After a period of time of 28 days of drying and hardening at room temperature and a relative humidity of 50% the specimen is dipped into and/or placed in the following liquids: 5% hydrochloric acid, 5% nitric acid, 5% butyric acid, 5% NaOH, acetone, diesel, methylated spirit. Also after a storage time of 14 days in the mentioned liquids the specimen does not show any appreciable changes of the surface, and also the load through an open flame with a temperature of up to 500° C. does not result in an appreciable damage of the surface.

### EXAMPLE 2

To a substance mixture consisting of 24% by weight of potassium water glass powder, 29% by weight of slag sand, 5% by weight of Portland cement, 0.5% by weight of lithium hydroxide, 0.5% by weight of lithium sulphate and 41% by weight of quartz sand, water is added and it is processed as in example 1, wherein corrugated board instead of a glass fibre weave is used for impregnation and the applied layer thickness is 2 mm on both sides of the corrugated board. After a period of time of 28 days of drying at the same conditions as in example 1, the following liquids are sprinkled onto the surface of the specimen: 5% hydrochloric acid, 5% nitric acid, 5% butyric acid, 5% NaOH, acetone, diesel, methylated spirit. The sprinkling is repeated daily for 14 days, wherein in each case the liquid remains on the surface of the specimen. Nevertheless, till the end of the trial period of 14 days no appreciable changes of the surface can be seen and also the load through a hot flame with a temperature of up to 500° C. does not result in an appreciable damage of the surface.

### EXAMPLE 3

To a substance mixture consisting of 21% by weight of potassium water glass powder, 28% by weight of slag sand, 7% by weight of Portland cement, 0.5% by weight of lithium hydroxide, 0.5% by weight of potassium sulphate and 33% by weight of quartz sand powder, water is mixed and subsequently 10% by weight of waste paper chips which have been soaked in water in advance are added. The result is an easily mouldable and modelable mass from which moulded articles and coatings having any structure can be moulded in an excellent way. Onto such a moulded article after a period of time of 28 days of drying at the same conditions as in example 1 the following liquids are sprinkled: 5% hydrochloric acid, 5% nitric acid, 5% butyric acid, 5% NaOH, acetone, diesel, methylated spirit. The sprinkling onto the surface of the moulded article is repeated daily for 14 days, wherein in each case the liquid remains on the surface of the specimen. Nevertheless, till the end of the trial period of 14 days no appreciable changes of the surface can be seen and also the load through a hot flame with a temperature of up to 200° C. does not result in an appreciable damage of the surface. When this composite material of construction is applied as a coating onto e.g. steel or glass, then this results in values of adhesive tensile strength of >5 N/mm².

### EXAMPLE 4

A substance mixture consisting of 30% by weight of potassium water glass powder, 20% by weight of slag sand, 6% by weight of Portland cement, 0.5% by weight of lithium hydroxide, 0.5% by weight of lithium sulphate and 23% by weight of glass powder is mixed with water and subsequently with 10% by weight of waste paper chips originating from newspapers and 10% by weight of expanding polystyrene having a particle size of ca. 3 mm. After mixing the result is an easily mouldable and modelable mass from which moulded articles and coatings having any structure can be moulded in an excellent way. Onto such a moulded article after a period of time of 28 days of drying at the same conditions as in example 1 the following liquids are sprinkled: 5% hydrochloric acid, 5% nitric acid, 5% butyric acid, 5% NaOH, acetone, diesel, methylated spirit. The sprinkling onto the surface of the moulded article is repeated daily for 14 days, wherein in each case the liquid remains on the surface of the specimen. Nevertheless, till the end of the trial period of 14 days no appreciable changes of the surface can be seen and also the load through a hot flame with a temperature of up to 100° C. does not result in an appreciable damage of the surface. When this composite material of construction is applied as a coating onto e.g. steel or glass, then this results in values of adhesive tensile strength of >5 N/mm².

1. Composite material of construction including at least one inorganic binder and a fibre material, characterized in that the inorganic binder is a water glass, the fraction of the composite material of construction which is attributable to water glass being in the range from 2% to 99% by weight and the fibre material being present as a weave and/or knit and/or scrim and/or net and/or fibrous nonwoven web and/or as hollow fibres.

2. Composite material of construction according to claim 1, wherein in said composite material of construction besides the water glass a cement or latent-hydraulic binder is present so that the formation of calcium hydroxide is prevented by the formulation and/or a catalyst.

3. Composite material of construction according to claim 1, characterized in that the fraction of the composite material of construction which is attributable to the fibre material being at least 0.001% by weight.

4. Composite material of construction according to claim 1, characterized in that it contains at least one further inorganic binder or at least one inorganic filler, the fraction of these substances and the fibre material together being in the range from 0.1% to 79% by weight, based on the composite material of construction.

5. Composite material of construction according to claim 1, characterized in that it contains
one or more water glasses and at least 10% by weight of one or more substances of the group consisting of slag sand, micro silica, slag, fly ash, trass powder, brick powder, oil shale, glass or quartz sand, or
water glass powder and at least one water glass hardener and more than 10% by weight of slag sand and at least one further inorganic filler, or
water glass powder and 10% to 60% by weight of a latent-hydraulic binder of the group consisting of slag sand, micro silica, fly ash, trass powder, brick powder, oil shale and cement, as well as 0.5% to 40% by weight of a substance which controls the setting reaction of the group consisting of metal hydroxide, metal oxide, carbonaceous metal salt, sulphurous metal salt, nitrogenous metal salt, phosphorus containing metal salt, halogen-containing metal salt.

6. Composite material of construction according to claim 1, characterized in that the fibre material being present as a weave, knit, scrim, net, fibrous nonwoven web or as hollow fibres consists of the inorganic materials glass or stone, the organic materials paper, wood, cellulose, polypropylene, polyethylene, aramid, carbon, nylon or polyethylene terephthalate or the metallic fibres such as iron, steel, titanium, gold, silver, molybdenum, tungsten or niobium.

7. Moulded article including or consisting of a composite material of construction according to claim 1.

8. Coating consisting of a composite material of construction according to claim 1.

9. Composite material of construction according to claim 1, characterized in that it is flexibilised, preferably by the admixture of gum granulate, PE, PP, atactic PE or PE, liquid polymer dispersions or powdery polymers such as pure acrylates, styrene acrylate, polyurethane, latex or rubber.
